(19) United States
(12) Patent Application Publication
(10) Pub. No.: US 2022/0281339 A1
(43) Pub. Date: Sep. 8, 2022

(54) POWER SUPPLY DEVICE, POWER SUPPLY SYSTEM, AND POWER SUPPLY METHOD FOR ELECTRIC VEHICLE

(71) Applicant: IHI Corporation, Tokyo (JP)

(72) Inventors: Motonao NIIZUMA, Tokyo (JP); Kenji II, Tokyo (JP); Koki NOTAKE, Tokyo (JP)

(73) Assignee: IHI Corporation, Tokyo (JP)

(21) Appl. No.: 17/750,829

(22) Filed: May 23, 2022

Related U.S. Application Data
(63) Continuation of application No. PCT/JP2021/002557, filed on Jan. 26, 2021.

(30) Foreign Application Priority Data
Jan. 31, 2020 (JP) 2020-014439

(51) Int. Cl. B60L 53/39; B60L 53/12; B60L 53/36; H02J 50/10; H02J 50/40; H02J 50/00

(52) U.S. Cl. CPC B60L 53/39; B60L 53/12; B60L 53/36; H02J 50/10; H02J 50/40; H02J 50/005

(57) ABSTRACT

A system includes: a power transmission coil in each of power supply spaces where electric vehicles can park in line one behind another from a head side to a tail side of the power supply spaces, and a power supply circuit supplying power to the electric vehicle via the power transmission coil when the power transmission coil faces a power reception coil in the electric vehicle. The system further includes: a controller making the electric vehicles park in line one behind another from the head side, moving one electric vehicle parked in a leading power supply space of the power supply spaces to a boarding area after stopping the power supply to the one electric vehicle, and moving another electric vehicle located behind the one electric vehicle to a power supply space at the head side.

### CROSS REFERENCE TO RELATED APPLICATIONS

This application is a continuation application of International Application No. PCT/JP2021/002557, filed on Jan. 26, 2021, which claims priority to Japanese Patent Application No. 2020-014439, filed on Jan. 31, 2020, the entire contents of which are incorporated by reference herein.

### BACKGROUND

### 1. Technical Field

The present disclosure relates to a power supply device, a power supply system, and a power supply method for an electric vehicle.

### 2. Description of the Related Art

As a power supply device that efficiently supplies power to a plurality of electric vehicles, for example, the power supply device disclosed in Japanese Patent Application Publication No. 2019-96102 (Patent Literature 1) is known. In Patent Literature 1, a standby area for a vehicle on standby, a power supply area for supplying power, and a completion area for parking a vehicle for which power supply has been completed are provided in a parking area of an expressway or the like. If a vehicle to be supplied with power is stopped in the standby area, it is then automatically moved to the power supply area to be supplied with power.

### SUMMARY

As described above, in the power supply device disclosed in Patent Literature 1, the vehicle is automatically moved to the power supply area to be supplied with electric power. However, the vehicles for which power supply has been completed and which have reached the target charge amount are sequentially moved to the completion area regardless of the order in which they entered the power supply area. Therefore, an empty space is created in the power supply area between vehicles that have not reached the target charge amount. However, when a vehicle is to be parked in such an empty space, an empty space having a length of about 1.5 times the vehicle length is required even when the vehicle is moved backward and parallel parked. Therefore, it is not possible to shorten the parking space of a vehicle that is to be supplied with power within the power supply area. In other words, the power supply device disclosed in Patent Literature 1 has a problem that it is not possible to secure a large number of spaces for supplying power in a limited area.

The present disclosure has been made to solve such a problem. An object of the present disclosure is to provide a power supply device, a power supply system, and a power supply method for an electric vehicle capable of securing more power supply spaces in a limited area.

In order to achieve the above object, a power supply device according to one aspect of the present disclosure is a device for wirelessly performing power supply to an electric vehicle having an automatic parking function, and includes: a power transmission coil provided in each of a plurality of power supply spaces in which electric vehicles are to park in line one behind another from a head side to a tail side of the power supply spaces, a power supply unit performing the power supply to the electric vehicle via the power transmission coil when the power transmission coil faces a power reception coil provided in the electric vehicle, and a vehicle movement control unit controlling making of two or more of the electric vehicles park in line one behind another from a power supply space at the head side of the power supply spaces, moving of one electric vehicle parked in a leading power supply space of the power supply spaces out of the leading power supply space after stopping the power supply to the one electric vehicle, and moving of another electric vehicle located behind the one electric vehicle to the power supply space at the head side.

A power supply system according to another aspect of the present disclosure includes: an electric vehicle having an automatic parking function, and a power supply device for wirelessly performing power supply to the electric vehicle, wherein the electric vehicle includes a power reception coil that receives power supplied from the power supply device, and the power supply device includes a power transmission coil provided in each of a plurality of power supply spaces in which the electric vehicles are to park in line one behind another from a head side to a tail side of the power supply spaces, a power supply unit configured to perform the power supply to the electric vehicle via the power transmission coil when the power transmission coil faces the power reception coil, and a vehicle movement control unit configured to control making of the electric vehicles park in line one behind another from a power supply space at the head side, moving of one electric vehicle parked in a leading power supply space of the power supply spaces out of the leading power supply space after stopping the power supply to the one electric vehicle, and moving of another electric vehicle located behind the one electric vehicle to the power supply space at the head side.

A power supply method according to another aspect of the present disclosure is a method for wirelessly performing power supply to an electric vehicle having an automatic parking function, includes: a step of moving the electric vehicle to be supplied with power into power supply spaces in which electric vehicles are to park in line one behind another from a head side to a tail side of the power supply spaces, a step of performing the power supply to the electric vehicle via a power transmission coil when the power transmission coil faces a power reception coil provided in the electric vehicle, the power transmission coil being provided in each of the power supply spaces, a step of making the electric vehicles park in line one behind another from a power supply space at the head side, a step of moving one electric vehicle parked in a leading power supply space of the power supply spaces out of the leading power supply space after stopping the power supply to the one electric vehicle, and a step of moving another electric vehicle located behind the one electric vehicle to the power supply space at the head side.

According to the present disclosure, it is possible to secure more power supply spaces in a limited area.

### BRIEF DESCRIPTION OF THE DRAWINGS

FIG. 1 is a block diagram showing a configuration of a power supply system according to an embodiment.

FIG. 2 is an explanatory view showing an arrangement of power supply spaces of the power supply system according to the embodiment.

FIG. 3 is a flowchart showing a procedure of moving an electric vehicle out of a power supply space and making an electric vehicle enter a power supply space.

FIG. 4A is a flowchart showing the details of the process of moving the electric vehicle out of the power supply space.

FIG. 4B is a flowchart showing the details of the process of making the electric vehicle enter the power supply space.

FIG. 5A is an explanatory view showing a first electric vehicle arrangement state when the electric vehicle is moved out of the power supply space.

FIG. 5B is an explanatory view showing a second electric vehicle arrangement state when the electric vehicle has been moved out of the power supply space.

FIG. 5C is an explanatory view showing a third electric vehicle arrangement state when the electric vehicle has been moved out of the power supply space.

FIG. 5D is an explanatory view showing a fourth electric vehicle arrangement state when the electric vehicle has been moved out of the power supply space.

FIG. 6A is an explanatory view showing a first electric vehicle arrangement state when making an electric vehicle enter the power supply space.

FIG. 6B is an explanatory view showing a second electric vehicle arrangement state when making an electric vehicle enter the power supply space.

FIG. 6C is an explanatory view showing a third electric vehicle arrangement state when making an electric vehicle enter the power supply space.

FIG. 6D is an explanatory view showing a fourth electric vehicle arrangement state when making an electric vehicle enter the power supply space.

FIG. 7 is an explanatory view showing a configuration in which power supply spaces are set in an area at the side of an obstacle.

FIG. 8 is an explanatory view showing a configuration in which power supply spaces are set in a curved area.

FIG. 9 is an explanatory view showing an example in which three systems of power supply spaces contiguous in the lengthwise direction are provided according to a first modification.

FIG. 10 is an explanatory view showing the positional relationship between a power reception coil unit of an electric vehicle parked in the power supply space and a power transmission coil unit provided in the power supply space according to a second modification.

FIG. 11A is a view showing an example in which an electric vehicle is moved along traveling lanes provided at an elevated place, as viewed from the side, according to a third modification.

FIG. 11B is a view showing an example in which the electric vehicle is moved along traveling lanes provided at an elevated place, as viewed from the rear in the traveling direction, according to the third modification.

### DESCRIPTION OF THE EMBODIMENTS

### Explanation of Configuration of Embodiment

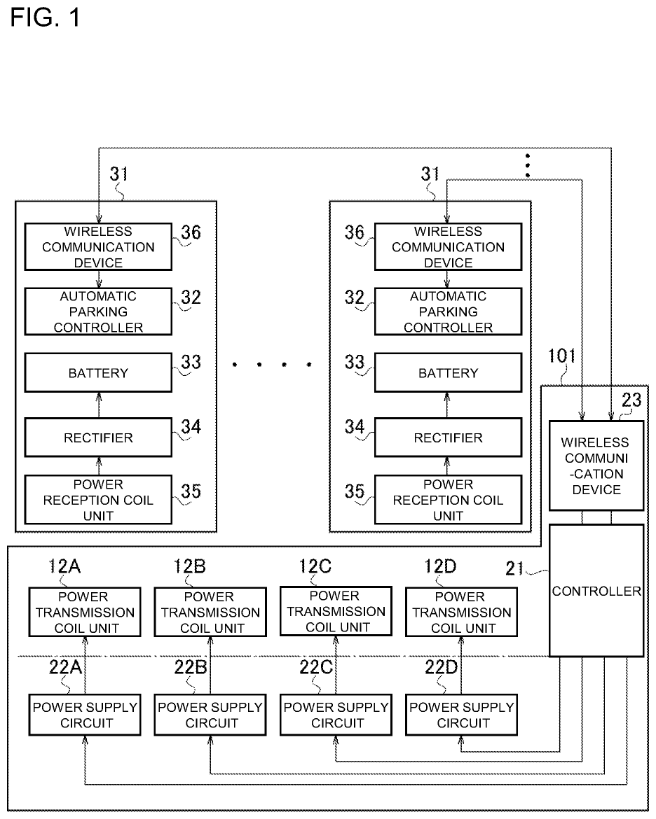

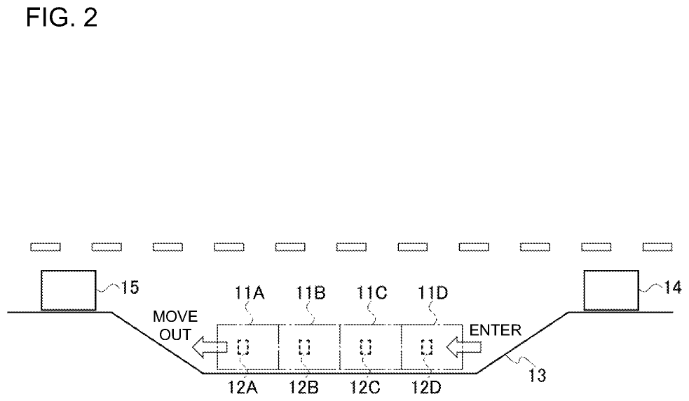

Hereinafter, some exemplary embodiments will be described with reference to the drawings. FIG. 1 is a block diagram showing a configuration of a power supply system according to an embodiment. FIG. 2 is an explanatory view showing an arrangement of power supply spaces of the power supply system according to the embodiment.

As shown in FIG. 1, the power supply system according to the present embodiment includes a power supply device 101 and a plurality of electric vehicles 31. Further, in the power supply system according to the present embodiment, as shown in FIG. 2, the electric vehicles 31 are parked in a plurality of power supply spaces 11 (11A to 11D) provided in the traveling direction of the vehicles (four spaces in the figure). Then, the power supply system according to the present embodiment wirelessly supplies electric power to the batteries provided in each electric vehicle 31. An alighting area 14 (power supply waiting area) is provided behind the power supply space 11. A boarding area 15 is provided in front of the power supply space 11.

In the following, when a specific power supply space is referred to, a suffix such as “A” is added as in “power supply space 11A”. Further, when a power supply space is referred to without specifying an individual power supply space, the power supply space is referred to as “power supply space 11” without adding a suffix. The same rule applies to other reference signs.

The electric vehicle 31 shown in FIG. 1 includes an automatic parking controller 32, a battery 33, a rectifier 34, a power reception coil unit 35, and a wireless communication device 36.

The wireless communication device 36 wirelessly communicates with the power supply device 101.

The automatic parking controller 32 parks the electric vehicle 31 in a desired parking area based on a parking command from the driver or from outside. For example, when a command signal to park in the power supply space 11A shown in FIG. 2 is given from outside, control is performed to automatically park the electric vehicle 31 in the power supply space 11A. A known technique may be adopted for the control of moving the electric vehicle 31 to a desired parking area.

For example, the movement of the electric vehicle 31 is controlled so that the power reception coil unit 35 is located directly above a power transmission coil unit 12 (details will be described later) provided in a desired power supply space 11, based on an image captured by a camera (not shown) or an intensity image/distance image obtained by LIDAR (laser imaging detection and ranging; not shown). Specifically, the steering, accelerator, and brakes of the electric vehicle 31 are operated to control the electric vehicle 31 to move to a desired power supply position. Alternatively, it is possible to acquire the latitude and longitude information of the power transmission coil unit 12 that is the target of movement and to park the electric vehicle 31 in the desired power supply space 11 based on the vehicle position information received by a GPS receiver (Global Positioning System receiver).

The automatic parking controller 32 may be configured as, for example, an integrated computer including a central processing unit (CPU) and storage means such as a RAM, a ROM, and a hard disk.

The battery 33 is, for example, a lithium-ion battery, and stores electric power for driving the electric vehicle 31.

The power reception coil unit 35 is entirely covered with a housing and has therein a power reception coil and either an inductor, a capacitor, or a matching circuit including an inductor and a capacitor. The power reception coil is, for example, a flat spiral coil formed by winding a litz wire.

Further, the power reception coil unit 35 is provided at the bottom of the electric vehicle 31 and comes to face the power transmission coil unit 12 provided in the power supply space 11 with a predetermined distance therebetween when the electric vehicle 31 is parked in the power supply space 11.

The rectifier 34 converts alternating current (AC) power received by the power reception coil unit 35 into direct current (DC) power by, for example, a rectifier circuit composed of a diode, and supplies the DC power to the battery 33. A DC-DC converter may be provided between the rectifier 34 and the battery 33. Further, the DC power output from the rectifier 34 may be supplied to the battery 33 and used as power for a vehicle-mounted device such as an air conditioner.

Meanwhile, the power supply device 101 shown in FIG. 1 includes four power transmission coil units 12 (12A to 12D), four power supply circuits 22 (22A to 22D), a controller 21, and a wireless communication device 23.

The power transmission coil unit 12 is entirely covered with a housing and has therein a power transmission coil and either an inductor, a capacitor, or a matching circuit including an inductor and a capacitor. The power transmission coil is, for example, a flat spiral coil formed by winding a litz wire. As shown in FIG. 2, each power transmission coil unit 12 is provided on the road surface of each power supply space 11 or is buried in the road surface.

The power supply circuit 22 includes a rectifier, a power factor correction circuit, and an inverter circuit (not all shown). The power supply circuit 22 converts the power supplied from a power source not shown into a desired voltage and a desired frequency (for example, 100 kHz) according to a command signal transmitted from the controller 21, and supplies the power to each power transmission coil unit 12. As the power source, a commercial power source (for example, 200 V, 50 Hz), a solar cell, or electric power obtained from wind power generation may be used. The power supply circuit 22 receives a command signal from the controller 21 by wiring or wirelessly. It is also possible to provide the power transmission coil unit 12 and the power supply circuit 22 in the same housing.

The power supply circuit 22 functions as a power supply unit that supplies electric power to the electric vehicle 31 via the power transmission coil when the power transmission coil provided in the power transmission coil unit 12 faces the power reception coil provided in the power reception coil unit 35.

The wireless communication device 23 performs wireless communication with the wireless communication device 36 of each electric vehicle 31 to be supplied with power. The wireless communication device 23 receives the power supply request signal by communication with each electric vehicle 31. In addition, the wireless communication device 23 transmits an automatic parking command signal to each electric vehicle 31.

The controller 21 controls the automatic parking of an electric vehicle 31 to be supplied with power. When it is detected that the electric vehicle 31 to be supplied with power is parked in the desired power supply space 11, the controller 21 performs control for power to be supplied to the power transmission coil unit 12 provided in the power supply space 11.

The controller 21 also moves the electric vehicle 31 to the boarding area 15 in front when the power supply to the electric vehicle 31 is stopped in the leading power supply space 11A among the four power supply spaces 11A to 11D. Further, the controller 21 stops the power supply to each electric vehicle 31 that is being supplied with power in the power supply spaces 11B, 11C, 11D, and performs the process of moving each electric vehicle 31 to the power supply spaces 11A, 11B, 11C. In addition, the controller 21 performs control for moving an electric vehicle 31 waiting in the alighting area 14 to the power supply space 11D.

That is, the controller 21 makes the electric vehicles 31 park in line one behind another from the head side of the power supply spaces 11. The controller 21 moves one electric vehicle 31 parked in the leading power supply space 11 out of the power supply spaces 11 after the power supply to the one electric vehicle 31 is stopped. The controller 21 has a function as a vehicle movement control unit that then moves another electric vehicle 31 located behind the one electric vehicle 31 to the power supply space 11 on the head side.

The controller 21 may be configured as, for example, an integrated computer including a central processing unit (CPU) and storage means such as a RAM, a ROM, and a hard disk.

### Explanation of Power Supply Space

As shown in FIG. 2, the power supply spaces 11 (11A to 11D) are contiguously arranged in the lengthwise direction (the traveling direction of the electric vehicles 31), and the power supply spaces 11 (11A to 11D) are provided with the power transmission coil units 12 (12A to 12D) respectively. The alighting area 14 is provided behind the power supply spaces 11, and the driver of an electric vehicle 31 gets off the vehicle in the alighting area 14. The electric vehicle 31 parked in the alighting area 14 moves to a desired power supply space 11 by means of the automatic parking function. For example, the electric vehicle 31 automatically moves to the leading power supply space 11A.

Meanwhile, the boarding area 15 is provided in front of the power supply space 11, and the electric vehicle 31 for which power supply has been completed moves to the boarding area 15 by means of the automatic parking function. The driver can board the electric vehicle 31 in the boarding area 15.

Further, the length of each power supply space 11 in the front-rear direction is set to be slightly longer than the vehicle length of the electric vehicle having the longest vehicle length (length in the front-rear direction of the vehicle) among the electric vehicles to be supplied with power. That is, in the present embodiment, all the electric vehicles 31 that have entered the power supply spaces 11 from the alighting area 14 move forward on the same route to a power supply space 11. Since the power is supplied in the power supply spaces 11, the vehicles do not overtake a vehicle in front to go out, and the vehicles do not enter a vacant power supply space 11 from the side by parallel parking or the like. Therefore, it is not necessary to increase the inter-vehicle distance from the front vehicle, and the length of each power supply space 11 in the front-rear direction may be slightly longer than the vehicle length. For example, the length of each power supply space 11 can be set to be longer than the vehicle length and shorter than 1.5 times the vehicle length.

### Explanation of Operation of Embodiment

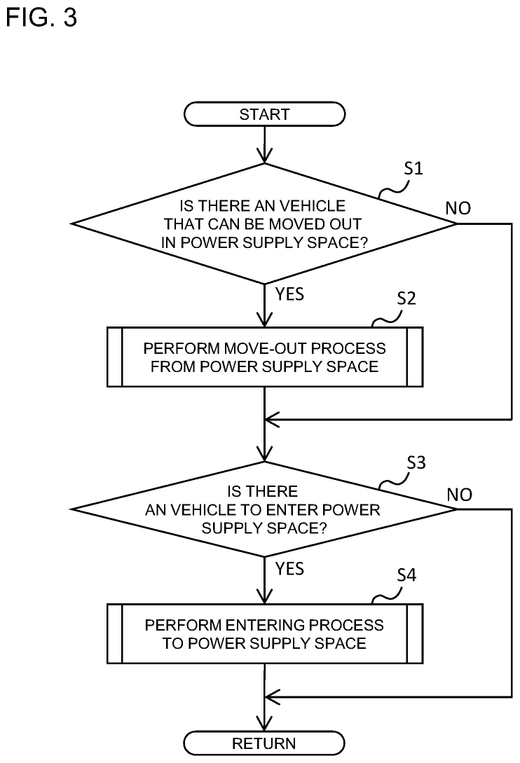

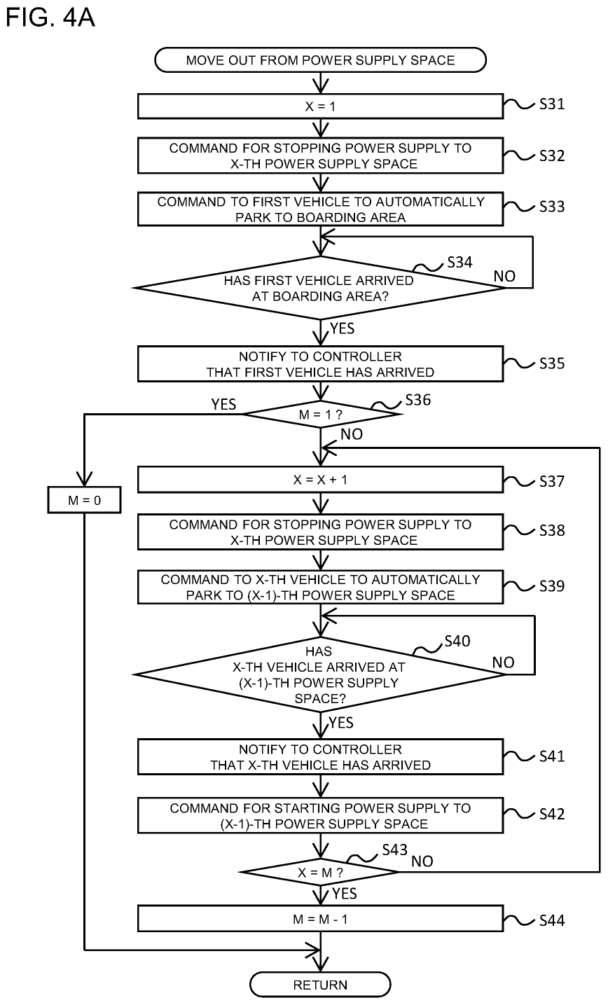

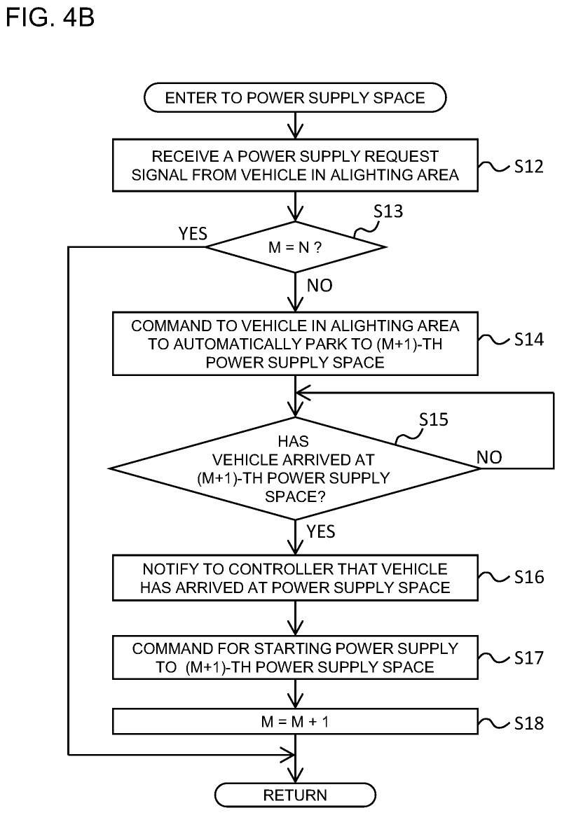

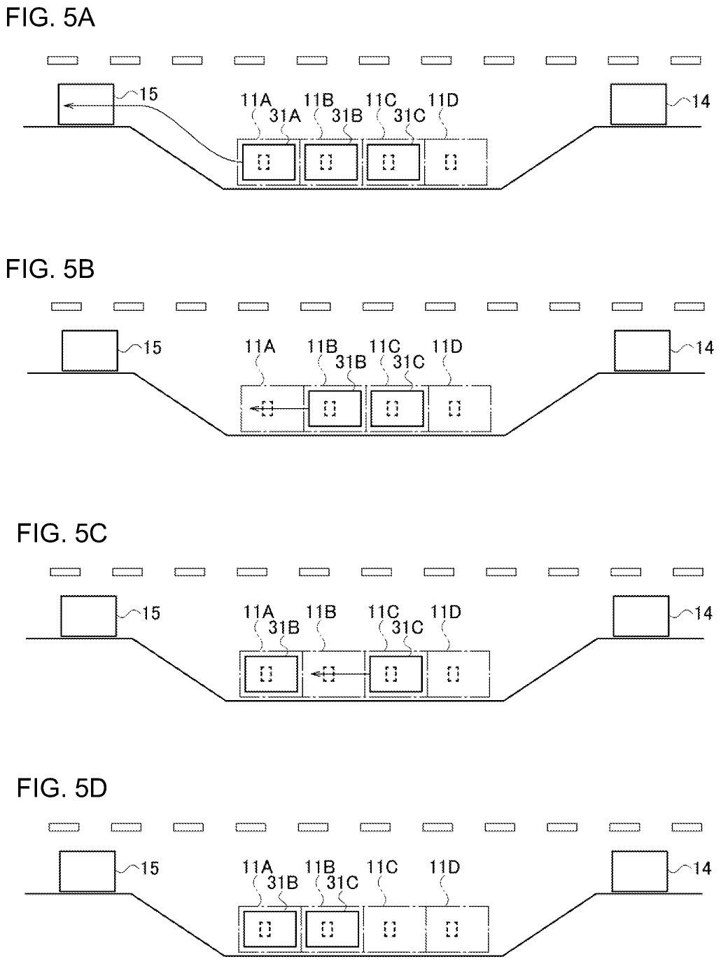

Next, the operation of the power supply system according to the present embodiment will be described. FIG. 3 is a flowchart showing a procedure for moving an electric vehicle 31 out of a power supply space 11 (“move-out process”) and for making an electric vehicle 31 enter a power supply space 11 (“entering process”). Further, FIG. 4A is a flowchart showing the details of step S2 shown in FIG. 3, and FIG. 4B is a flowchart showing the details of step S4 shown in FIG. 3. FIGS. 5A, 5B, 5C, and 5D are explanatory views showing the movement of electric vehicles 31 when the electric vehicle 31 moves out of the power supply space 11. FIGS. 6A, 6B, 6C, and 6D are explanatory views showing the movement of electric vehicles 31 when the electric vehicle 31 enters the power supply space.

In the following description, it is assumed that the number of power supply spaces 11 is set in advance as “N”. Note that N≥1. Since there are four power supply spaces 11A to 11D in the present embodiment, N=4.

“M” is a variable that stores the number of electric vehicles 31 parked in the power supply spaces 11, and is any value in the range of 0≤M≤N. It is assumed that M is initialized to 0 at the time when the power supply system starts operation (the state in which no electric vehicle 31 is parked in the power supply spaces 11). By the processing step described in detail below, the value of M is increased by 1 when one electric vehicle 31 enters the power supply space 11. Further, the value of M is decreased by 1 when one electric vehicle 31 moves out of the power supply space 11. That is, the value of M always indicates the number of electric vehicles 31 parked in the power supply spaces 11.

As shown in FIG. 3, in step S1, the controller 21 of the power supply device 101 shown in FIG. 1 determines whether there is an electric vehicle 31 that can be moved out of the power supply spaces 11. If there is an electric vehicle 31 that can be moved out (S1; YES), the process proceeds to step S2. In step S2, the process to move the electric vehicle 31 out from the power supply spaces 11 is performed. If there is no electric vehicle 31 that can be moved out (S1; NO), the process proceeds to step S3.

In step S3, the controller 21 determines whether there is an electric vehicle 31 that is to enter the power supply spaces 11. If there is an electric vehicle 31 that is to enter (S3; YES), the process proceeds to step S4. In step S4, the process to enter the power supply spaces is performed. If there is no electric vehicle 31 that is to enter (S3; NO), this process ends.

Next, a processing procedure for moving an electric vehicle 31 out of the power supply space 11 will be described with reference to FIGS. 4A, 5A, 5B, 5C, and 5D. Here, as shown in FIGS. 5A, 5B, 5C, and 5D, a case where power is being supplied in the three power supply spaces 11A, 11B, and 11C will be described as an example. “M” always indicates the number of electric vehicles 31 parked (supplied with power) in the power supply spaces 11 by means of the processing procedure described below. In the case of the process to move out from the power supply spaces, since at least one electric vehicle 31 is parked in the power supply spaces 11, M≥1. In the examples shown in FIGS. 5A, 5B, 5C, and 5D, M=3. In step S31 of FIG. 4A, the controller 21 of the power supply device 101 sets the variable X to “X=1”. X is a variable that specifies one power supply space (any of 11A to 11D in the present embodiment), and is any value in the range of 1≤X≤N.

In step S32, the controller 21 transmits a command signal for stopping the power supply to the power supply circuit 22A provided in the X^{th} (that is, the first) power supply space 11A from the front of the power supply spaces 11. That is, as shown in FIG. 5A, the controller 21 transmits the command signal to stop the power supply to the power supply circuit 22A (see FIG. 1) provided in the leading power supply space 11A and stops the power supply. Then, the controller 21 stops the power supply to the electric vehicle 31 parked in the power supply space 11A.

In step S33, the controller 21 transmits a command signal to the first electric vehicle 31A to automatically park in the boarding area 15 as the target. As a result, the automatic parking controller 32 of the electric vehicle 31A moves the electric vehicle 31A and automatically parks the electric vehicle 31A in the boarding area 15.

In step S34, the automatic parking controller 32 of the electric vehicle 31A determines whether the vehicle has arrived at the boarding area 15. If the vehicle has arrived (S34; YES), in step S35, the automatic parking controller 32 transmits a signal indicating that the vehicle has parked in the boarding area 15 to the power supply device 101.

In step S36, the controller 21 determines whether “M=1”. That is, the controller 21 determines whether there is one electric vehicle 31 parked in the four power supply spaces 11. If “M=1” (S36; YES), M is set to “0” and the move-out process (process in step S2 of FIG. 3) ends. That is, since the number of electric vehicles 31 is one, when the electric vehicle 31 moves to the boarding area 15, no electric vehicle 31 is parked in the power supply spaces 11, and the move-out process ends.

On the other hand, if M is not equal to “1” (S36; NO), in step S37, the controller 21 sets “X=X+1” (i.e., increments X by 1).

In step S38, the controller 21 transmits a command signal to stop the power supply to the power supply circuit 22 provided in the X^{th} power supply space 11 from the front of the power supply spaces 11. For example, the controller 21 transmits the command signal to stop the power supply to the power supply circuit 22B provided in the second power supply space 11B from the front of the power supply spaces 11 and stops the power supply to the electric vehicle 31B parked in the power supply space 11B.

In step S39, the controller 21 transmits a command signal to the X^{th} electric vehicle 31 to automatically park in the “X−1”^{th} power supply space 11. That is, as shown in FIG. 5A, the leading electric vehicle 31A moves to the boarding area 15, and as shown in FIG. 5B, the leading power supply space 11A is vacant. Therefore, the controller 21 stops the power supply to the electric vehicle 31B supplied in the second power supply space 11B and moves the electric vehicle 31B to the power supply space 11A.

In step S40, the automatic parking controller 32 of the X^{th} electric vehicle 31 performs control for parking in the “X−1”^{th} power supply space 11 by means of the automatic parking function, and determines whether the X^{th} electric vehicle 31 arrives at the “X−1”^{th} power supply space 11. Specifically, the automatic parking controller 32 determines whether the power reception coil unit 35 is located at a position facing the power transmission coil unit 12 provided in the power supply space 11 or within a predetermined misalignment range from the position. If the electric vehicle 31 is parked in the power supply space 11 (S40; YES), the process proceeds to step S41.

In step S41, the wireless communication device 36 of the X^{th} electric vehicle 31 transmits a signal indicating that the electric vehicle 31 has arrived at the “X−1”^{th} power supply space 11 to the controller 21.

In step S42, the controller 21 transmits a command signal instructing the start of power supply to the power supply circuit 22 provided in the “X−1”^{th} power supply space 11. For example, as shown in FIG. 5B, it is assumed that the electric vehicle 31B parked in the power supply space 11B moves to the power supply space 11A. In this case, the controller 21 transmits a command signal instructing the power transmission coil unit 12A to start power supply to the power supply circuit 22A provided in the power supply space 11A. As a result, it becomes possible to supply power to the electric vehicle 31B parked in the power supply space 11A.

In step S43, the controller 21 determines whether “X=M” is satisfied. If “X=M” is not satisfied (S43; NO), the process returns to step S37. That is, as shown in FIG. 5C, the controller 21 moves the electric vehicle 31C parked in the third power supply space 11C from the front of the power supply spaces 11 to the preceding power supply space 11B. After the movement, the electric vehicle 31C is supplied with power in the power supply space 11B as shown in FIG. 5D.

In this way, when the power supply to the electric vehicle 31 is completed in the leading power supply space 11A and the vehicle moves to the boarding area 15, the succeeding electric vehicle 31 is sequentially moved to the preceding power supply space 11 to continue the power supply.

On the other hand, if “X=M” is satisfied (S43; YES), in step S44, the controller 21 sets “M=M−1” (i.e., decrements M by 1) and ends the move-out process. That is, the number of electric vehicles 31 parked in the power supply space 11 is decreased by one.

Next, a processing procedure for making an electric vehicle 31 enter the power supply spaces 11 will be described with reference to FIGS. 4B, 6A, 6B, 6C, and 6D. In step S12 of FIG. 4B, the controller 21 of the power supply device 101 shown in FIG. 1 communicates with an electric vehicle 31 parked in the alighting area 14 and receives a power supply request signal from the electric vehicle 31. That is, when the driver of the electric vehicle 31 wants power to be supplied to the electric vehicle 31, the driver parks the electric vehicle 31 in the alighting area 14 shown in FIG. 6A. Further, the driver transmits a power supply request signal from the wireless communication device 36 (see FIG. 1). After that, the driver gets off the electric vehicle 31. This request signal is received by the wireless communication device 23 of the power supply device 101.

A unique ID number is assigned to each electric vehicle 31, and the wireless communication device 23 receives the ID number from each electric vehicle 31 and stores the received ID number in a storage unit such as a memory. According to this configuration, a plurality of electric vehicles 31 can be managed by means of ID numbers.

“M” always indicates the number of electric vehicles 31 parked (supplied with power) in the power supply spaces 11 according to the processing procedures described so far and described below. For example, as shown in FIG. 6A, when no electric vehicle 31 is parked in all the power supply spaces 11, “M=0”.

In step S13, the controller 21 determines whether “M=N” is satisfied. When M=N is satisfied (S13; YES), the entering process (process in step S4 of FIG. 3) ends. That is, when an electric vehicle 31 is parked in all the four power supply spaces 11A to 11D, the electric vehicle 31 parked in the alighting area 14 cannot enter the power supply spaces 11. Therefore, the controller 21 does not perform the process of making the electric vehicle 31 enter the power supply spaces 11.

On the other hand, when M=N is not satisfied (S13; NO), in step S14, the controller 21 sends a command signal to the electric vehicle 31 parked in the alighting area 14 to make the electric vehicle 31 automatically park at the “M+1”^{th} power supply space 11 from the front of the power supply spaces 11. For example, as shown in FIG. 6A, if an electric vehicle 31 is not parked in any of the power supply spaces 11, “M=0” is satisfied. Thus, the controller 21 sends a command signal to the electric vehicle 31 to make the electric vehicle 31 automatically park at the first power supply space 11A.

In step S15, the automatic parking controller 32 of the electric vehicle 31 performs control for parking in the “M+1”^{th} power supply space 11 by means of the automatic parking function and determines whether the electric vehicle 31 has arrived at the power supply space 11. Specifically, the automatic parking controller 32 determines whether the power reception coil unit 35 is located at a position facing the power transmission coil unit 12 provided in the power supply space 11 or within a predetermined misalignment range from the position. If the electric vehicle 31 is parked in the power supply space 11 (S15; YES), the process proceeds to step S16.

In step S16, the wireless communication device 36 of the electric vehicle 31 transmits a signal indicating that the electric vehicle 31 has arrived at the power supply space 11 and the ID number of the electric vehicle 31 to the power supply device 101.

In step S17, the controller 21 transmits a command signal instructing the start of power supply to the power supply circuit 22 provided in the power supply space 11 in which the electric vehicle 31 is parked. For example, as shown in FIG. 6B, it is assumed that the electric vehicle 31A is parked in the power supply space 11A. In this case, the controller 21 transmits a command signal instructing the power transmission coil unit 12A to start power supply to the power supply circuit 22A provided in the power supply space 11A. As a result, it becomes possible to supply power to the electric vehicle 31A parked in the power supply space 11A.

In step S18, the controller 21 sets “M=M+1” (i.e., increments M by 1) and ends the entering process. That is, the number of electric vehicles 31 parked in the power supply space 11 is increased by one.

If power is supplied to the electric vehicle 31A in the leading power supply space 11A as shown in FIG. 6B, “M=1” is satisfied. Therefore, when the entering process is performed in this case, the controller 21 transmits a command signal for automatically parking in the second power supply space 11B to an electric vehicle 31 waiting in the alighting area 14. As a result, the state shown in FIG. 6C is reached, “M=2” is satisfied, and the entering process ends.

If power is supplied to the electric vehicles 31A and 31B in the power supply spaces 11A and 11B as shown in FIG. 6C, “M=2” is satisfied. Therefore, when the entering process is performed in this case, the controller 21 transmits a command signal for automatic parking to the third power supply space 11C to an electric vehicle 31 waiting in the alighting area 14. As a result, the state shown in FIG. 6D is reached, “M=3” is satisfied, and the entering process ends.

If power is supplied to the electric vehicles 31A, 31B, 31C in the power supply spaces 11A, 11B, 11C as shown in FIG. 6D, “M=3” is satisfied. Therefore, when the entering process is performed in this case, the controller 21 transmits a command signal for automatically parking in the fourth power supply space 11D to an electric vehicle 31 waiting in the alighting area 14. As a result, the entering process ends with “M=4”.

By performing the entering process a plurality of times in this way, with respect to the four power supply spaces 11 (11A to 11D) provided from the head side to the tail side, it is possible to park the electric vehicles 31 in sequence from the power supply space 11A on the head side to the tail side and to supply power to the electric vehicles 31.

In reality, the electric vehicle entering and the electric vehicle leaving are present at the same time, so the operation shown in the flowchart in FIG. 3 is repeated. For example, it works as follows.

At first, as shown in FIG. 6A, no electric vehicle 31 is parked in the power supply spaces 11 (M=0). Since there is no vehicle that can be moved out in step S1 (S1; NO), the process proceeds to step S3. If the alighting area 14 is empty (S3; NO), the process shown in the flowchart in FIG. 3 ends, and the process is repeated from step S1. If the alighting area 14 is empty, this operation is repeated, and neither the entering process nor the move-out process is performed.

When an electric vehicle 31 is parked in the alighting area 14 and there is an electric vehicle 31 to enter the power supply spaces 11 in step S3 (S3; YES), the entering process is performed. As shown in FIG. 6B, power is being supplied to the electric vehicle 31 in the power supply space 11A (M=1).

The process shown in the flowchart in FIG. 3 is repeated, and if the alighting area 14 is empty (S3; NO), the process shown in the flowchart in FIG. 3 ends, and the process is repeated from step S1. If the alighting area 14 is empty, this operation is repeated, and power supply to the electric vehicle 31 parked in the power supply space 11A continues.

When another electric vehicle 31 is parked in the alighting area 14 and there is an electric vehicle 31 to enter the power supply space 11 in step S3 (S3; YES), the entering process is performed. As shown in FIG. 6C, power is being supplied to the electric vehicles 31 in the power supply spaces 11A and 11B (M=2).

The process shown in the flowchart in FIG. 3 is repeated, and if the alighting area 14 is empty (S3; NO), the process shown in the flowchart in FIG. 3 ends, and the process is repeated from step S1. If the alighting area 14 is empty, this operation is repeated, and power supply to the electric vehicles 31 parked in the power supply spaces 11A and 11B is continued.

When yet another electric vehicle 31 is parked in the alighting area 14 and there is an electric vehicle 31 to enter the power supply space 11 in step S3 (S3; YES), the entering process is performed. As shown in FIG. 6D (or FIG. 5A showing the same state as FIG. 6D), power is being supplied to the electric vehicles 31 in the power supply spaces 11A, 11B and 11C (M=3).

The process shown in the flowchart in FIG. 3 is repeated, and if the alighting area 14 is empty (S3; NO), the process shown in the flowchart in FIG. 3 ends, and the process is repeated from step S1. If the alighting area 14 is empty, this operation is repeated, and power supply to the electric vehicles 31 parked in the power supply spaces 11A, 11B, and 11C is continued.

If the electric vehicle 31 parked in the power supply space 11A is fully charged, it is determined in step S1 that there is an electric vehicle 31 that can be moved out (S1; YES), and the move-out process is performed. The fully charged electric vehicle 31 moves to the boarding area 15, and the state of the electric vehicles 31 in the power supply spaces 11 changes sequentially as shown in FIGS. 5A, 5B, 5C, and FIG. 5D (or FIG. 6C showing the same state as FIG. 5D) (M=2).

The process shown in the flowchart in FIG. 3 is repeated, and if the electric vehicle 31 parked in the power supply space 11A is not fully charged in step S1 (S1; NO) and the alighting area 14 is empty in step S3 (S3; NO), the process shown in the flowchart in FIG. 3 ends. Then, the process is repeated from step S1. The power supply to the electric vehicles 31 parked in the power supply spaces 11A and 11B continues.

If the electric vehicle 31 parked in the power supply space 11A is fully charged in step S1 (S1; YES), the move-out process is performed, and then M=1 (as shown as the state in FIG. 6B). If an electric vehicle 31 is parked in the alighting area 14 and there is an electric vehicle 31 to enter the power supply spaces 11 in step S3 (S3; YES), the entering process is performed. Then, M=3 (as shown as the state in FIG. 6D).

As illustrated above, by repeating the process shown in the flowchart in FIG. 3, when the electric vehicle 31 supplied with power in the leading power supply space 11A is fully charged, the electric vehicle 31 is moved out to the boarding area 15. Then, the vehicle parked in the alighting area 14 can be made to enter the power supply spaces 11, and a state can be maintained in which the plurality of electric vehicles 31 supplied with power always move only in the forward direction and are parked in line one behind another. The process to move out from the power supply spaces and the process to enter the power supply spaces of an electric vehicle may be performed alternately, the move-out process may be performed consecutively, the entering process may be performed consecutively, and the move-out process and the entering process may be performed in any order.

### Explanation of the Effect of the Embodiment

In this way, in the power supply system for an electric vehicle according to the present embodiment, a plurality of power supply spaces 11 are contiguously provided in the lengthwise direction. If an electric vehicle 31 to be supplied with power is parked in the alighting area 14, the electric vehicle 31 is advanced by using the automatic parking function of the electric vehicle 31 and is parked in a power supply space 11 as close as possible to the head side and is wirelessly supplied with power. After that, if the electric vehicle 31A, which is being supplied with power in the leading power supply space 11A, is fully charged, the power supply to the electric vehicle 31A ends and the electric vehicle 31A is moved to the boarding area 15 in front of the leading power supply space 11A. Further, each of the subsequent electric vehicles 31 is advanced, moved to the preceding power supply space 11, and the power supply is restarted.

Therefore, it is possible to supply power to each of a plurality of electric vehicle 31 to be supplied with power, while only moving the electric vehicles 31 forward along the same route. Therefore, it is not necessary for the rear electric vehicle 31 to move out before the front electric vehicle 31 or for an electric vehicle 31 to enter the power supply spaces 11 from the side by parallel parking, and thus the length of each power supply space 11 can be shortened. For example, the length of each power supply space 11 can be set to a length slightly longer than the length of the vehicle having the longest vehicle length among the electric vehicles 31 to be supplied with power.

Specifically, as described above, if a vehicle is to be parked by parallel parking into a plurality of power supply spaces 11 provided in the lengthwise direction, the length of each power supply space 11 must be at least 1.5 times the vehicle length. However, according to the present embodiment, the length of each power supply space 11 can be set longer than the vehicle length and shorter than 1.5 times the vehicle length. Therefore, more power supply spaces 11 can be provided in a limited area, and the area can be effectively utilized.

Further, power is wirelessly supplied from the power supply device 101 to an electric vehicle 31, and communication between the power supply device 101 and the electric vehicle 31 is performed by wireless communication. Thus, there is no need for a cable, which would restrict the movement of the electric vehicle 31 between the power supply device 101 and the electric vehicle 31. Furthermore, there is no need to attach or detach a cable. Therefore, the operation described above is automatically performed without human intervention. The driver of the electric vehicle 31 can park and get off the electric vehicle 31 in the alighting area 14, and after a while can get on the electric vehicle 31 which has moved to the boarding area 15. It is possible to supply power to the electric vehicle 31 in this extremely simple procedure.

Further, since the electric vehicle 31 is moved to the desired power supply space 11 by using the GPS receiver, it is possible to accurately align the power reception coil unit 35 and the power transmission coil unit 12.

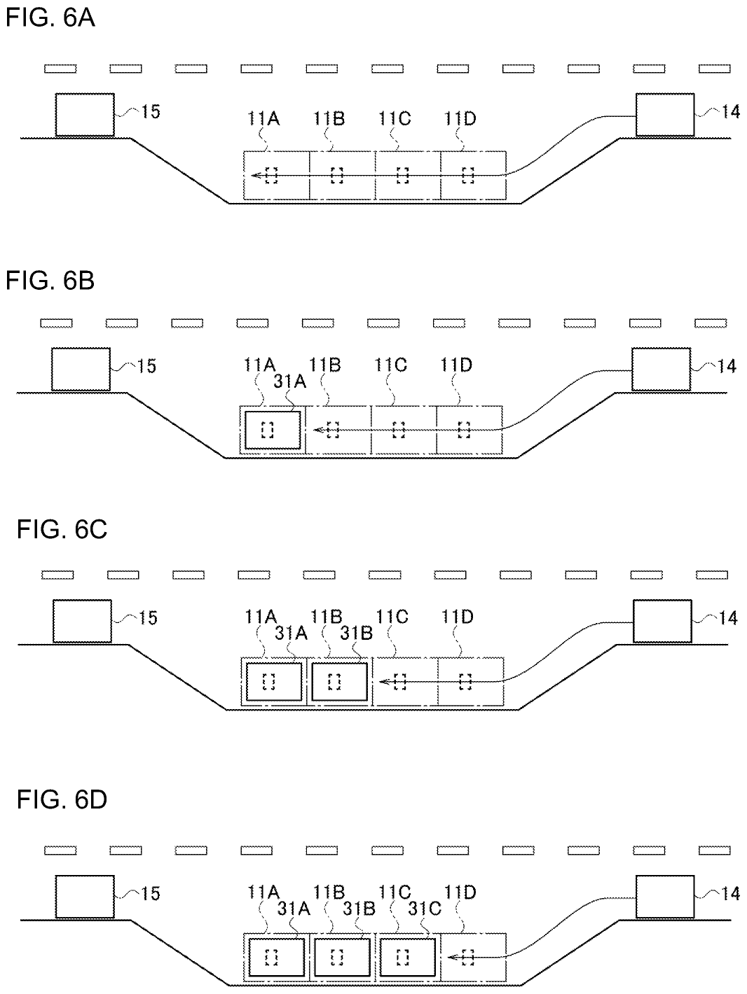

Further, as shown in FIG. 7, if an obstacle 51 such as a curb or a wall exists at the side of a plurality of power supply spaces 11 provided contiguously in the lengthwise direction, the vehicle cannot be moved to the side. However, this area can be effectively used as an area for wireless power supply.

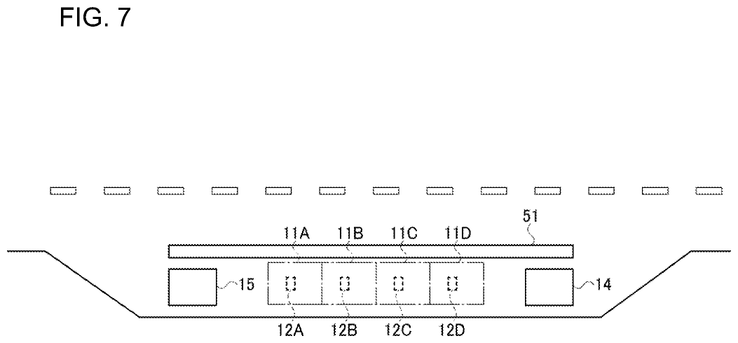

Further, as shown in FIG. 8, even in a narrow area forming a vertically curved shape through which one vehicle is able to pass, it is possible to provide a plurality of power supply spaces 11 in this area.

The above-described embodiment describes, as an example, performing a process of determining that there is an electric vehicle that can be moved out if the electric vehicle 31A supplied with power in the leading power supply space 11A is fully charged, and of moving the electric vehicle out of the power supply space. However, the present disclosure is not limited to this.

For example, it is also possible to perform a process of determining that there is an electric vehicle that can be moved out if a power supply time (a duration time of the power supply) of the electric vehicle 31A reaches a predetermined threshold time (reference time) in the leading power supply space 11A regardless of whether the battery is fully charged or not. It is also possible to perform a process of moving the electric vehicle out of the power supply space. With such a configuration, it is possible to avoid problems such as the subsequent vehicle being kept waiting for a long time.

Further, it is possible to perform a process of determining that the leading electric vehicle 31A can be moved out and of moving the electric vehicle 31A out of the power supply space when an electric vehicle 31 waiting for power supply is parked in the alighting area 14. With such a configuration, it is possible to avoid having the electric vehicle 31 waiting for power supply wait for a long time.

Further, it is also possible to control the movement of the leading electric vehicle 31 by using a plurality of conditions in combination. For example, when at least one of the following conditions (1) to (3) is satisfied, it is possible to perform a process of determining that there is an electric vehicle that can be moved out and of moving the electric vehicle out of the power supply space.

(1) The electric vehicle 31 supplied with power in the leading power supply space 11A is fully charged.

(2) The power supply time of the electric vehicle 31 supplied with power in the leading power supply space 11A has reached the upper limit of a power supply time.

(3) The waiting time of the electric vehicle 31 waiting in the alighting area 14 has reached the upper limit of a waiting time.

By setting such conditions, it is possible to perform highly convenient power supply depending on the installation conditions of the power supply device 101, for example, whether power is to be supplied to a car used for commuting at the workplace or to a shopper's car at the shopping center.

In the above-described embodiment, an example of supplying electric power by using a magnetic coupling between a power transmission coil and a power reception coil is given as the wireless power supply method, but other wireless power supply methods can also be adopted.

### Explanation of First Modification

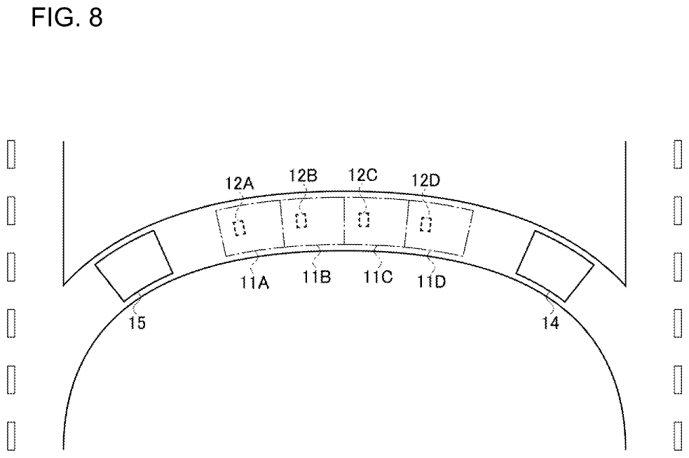

Next, a first modification of the above-described embodiment will be described. FIG. 9 is an explanatory view showing a power supply space of the wireless power supply system according to the first modification.

As shown in FIG. 9, the first modification shows an example in which a plurality of systems (three systems in the figure) of power supply spaces 11 contiguous in the lengthwise direction are provided. With such a configuration, a vacant system is selected from the plurality of systems of power supply spaces 11, and an electric vehicle 31 waiting for power supply in the alighting area 14 is moved to a power supply space 11 for power supply. Further, it is possible to provide more power supply spaces 11 by effectively utilizing the area long in the lengthwise direction and the transverse direction.

### Explanation of Second Modification

Next, a second modification will be described. In the above-described embodiment, the electric vehicles 31 to be supplied with power in the power supply spaces 11 are intended to be electric vehicles 31 of an arbitrary size. However, in the second modification, electric vehicles of the same type are to be supplied with power, for example, commercial vehicles or vehicles used for car sharing.

Since the vehicle length is constant for vehicles of the same vehicle type, the length of the power supply space 11 can be set according to the vehicle length. Specifically, as described above, the length of the power supply space 11 can be set to be longer than the vehicle length and shorter than 1.5 times the vehicle length.

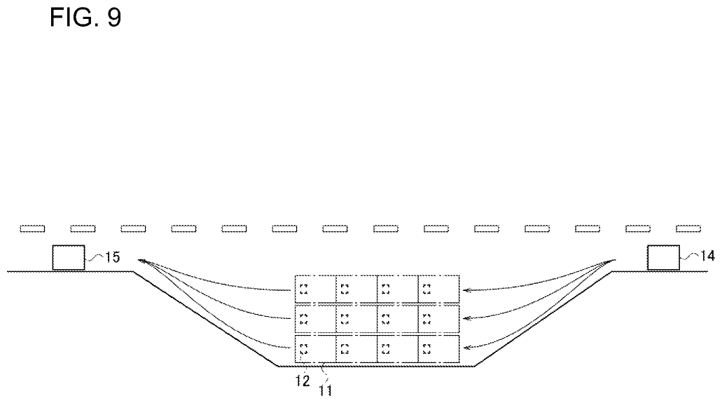

Hereinafter, the relationship between the power supply space 11 and the parking position of the electric vehicle 31 will be described with reference to FIG. 10. FIG. 10 is an explanatory view showing the positional relationship between the power transmission coil units 12A to 12C installed in the three power supply spaces 11A to 11C and the power reception coil units 35A to 35C installed in the electric vehicles 31A to 31C.

The allowable range of misalignment between the power transmission coil unit 12 and the power reception coil unit 35 is set as a distance α on the rear side and a distance on the front side with respect to the power transmission coil unit 12. If the misalignment is within the allowable range, the power transmission coil unit can efficiently perform wireless power supply to the power reception coil unit. The electric vehicle 31 may be parked within this range. Therefore, even if the electric vehicle 31A is displaced rearward by the distance α and the electric vehicle 31B is displaced forward by the distance β, a distance LV (the length of the power supply space 11) between the power transmission coil units 12 may be set so that the vehicles do not come into contact with each other. That is, the distance LV may be set longer than “vehicle length+α+β”. Therefore, unlike the conventional case, it is not necessary to secure a space to the extent that parallel parking is possible, and it is possible to secure a large number of power supply spaces 11 in a certain area.

### Explanation of Third Modification

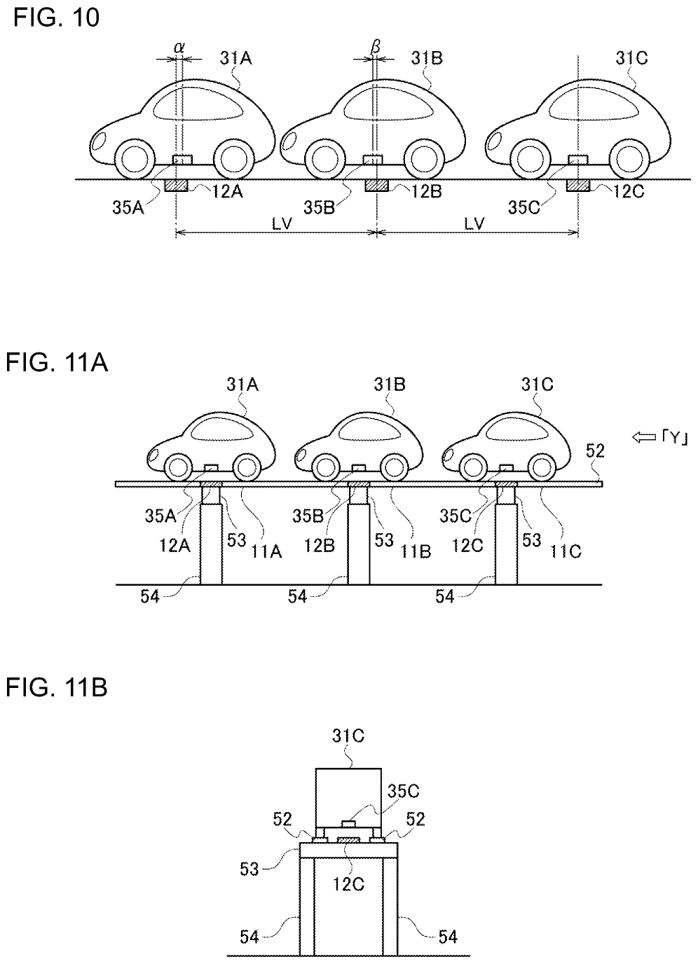

Next, a third modification will be described. FIGS. 11A and 11B are explanatory views showing power supply spaces 11 of the wireless power supply system according to the third modification; FIG. 11A is a side view, and FIG. 11B is a view as viewed from the “Y” direction shown in FIG. 11A. As shown in FIGS. 11A and 11B, in the third modification, there is no road surface, and left and right traveling lanes 52 that are separate from each other are provided along the traveling direction of the electric vehicle 31 in the power supply spaces 11 at positions where the tires of the electric vehicle 31 travel. Further, power transmission coil units 12 are provided between the left and right traveling lanes 52. The traveling lanes 52 and the power transmission coil units 12 are supported by columns 54 and beams 53, and the electric vehicles 31 travel on the traveling lanes 52. Since the electric vehicles 31 move forward on the same route in the power supply spaces 11, the electric vehicles 31 can be supported by the traveling lanes 52 provided only at the positions where the tires travel. With such a configuration, the power supply spaces 11 can be provided at an elevated place on a second floor or higher.

According to the present disclosure, it is possible to secure more power supply spaces in a limited area, for example, and thus it is possible to contribute to Goal 7 of the United Nations-led Sustainable Development Goals (SDGs): “Ensure access to affordable, reliable, sustainable and modern energy for all.”

Although some embodiments have been described, it is possible to change or modify the embodiments based on the above disclosed content. All the components of the above embodiment and all the features described in the claims may be individually extracted and combined as long as they do not contradict each other.

What is claimed is:

1. A power supply device for wirelessly performing power supply to an electric vehicle having an automatic parking function, the power supply device comprising:
a power transmission coil provided in each of a plurality of power supply spaces in which electric vehicles are to park in line one behind another from a head side to a tail side of the power supply spaces,
a power supply unit performing the power supply to the electric vehicle via the power transmission coil when the power transmission coil faces a power reception coil provided in the electric vehicle, and
a vehicle movement control unit controlling
making of two or more of the electric vehicles park in line one behind another from a power supply space at the head side,
moving of one electric vehicle parked in a leading power supply space of the power supply spaces out of the leading power supply space after stopping the power supply to the one electric vehicle, and
moving of another electric vehicle located behind the one electric vehicle to the power supply space at the head side.

2. The power supply device according to claim 1, wherein
the vehicle movement control unit is configured to stop the power supply to the electric vehicle supplied with power in the leading power supply space if the electric vehicle supplied with power in the leading power supply space is fully charged.

3. The power supply device according to claim 1, wherein
the vehicle movement control unit is configured to stop the power supply to the electric vehicle supplied with power in the leading power supply space if a duration time of the power supply to the electric vehicle in the leading power supply space reaches a predetermined reference time.

4. The power supply device according to claim 1, wherein
the vehicle movement control unit is configured to stop the power supply to the electric vehicle in the leading power supply space if the power supply to the electric vehicles is performed in all the power supply spaces and there is another electric vehicle parked in a power supply waiting area where the other electric vehicle waits for the power supply.

5. The power supply device according to claim 1, wherein
the vehicle movement control unit is configured to move yet another electric vehicle located behind the one electric vehicle to a power supply space that is as close as possible to the head side of the supply spaces after moving the one electric vehicle for which the power supply has been performed in the leading power supply space.

6. The power supply device according to claim 1, wherein
the vehicle movement control unit is configured
to acquire position information of the electric vehicle from a global positioning system receiver mounted on the electric vehicle, and
to move the electric vehicle to a desired power supply space based on the position information.

7. The power supply device according to claim 1, wherein
a vehicle length of the electric vehicles to be supplied with power in the power supply spaces is constant, and a length of each power supply space is longer than the vehicle length and shorter than 1.5 times the vehicle length.

8. A power supply system comprising:
an electric vehicle having an automatic parking function, and
a power supply device for wirelessly performing power supply to the electric vehicle, wherein
the electric vehicle includes a power reception coil that receives power supplied from the power supply device, and
the power supply device includes
a power transmission coil provided in each of a plurality of power supply spaces in which electric vehicles are to park in line one behind another from a head side to a tail side of the power supply spaces,
a power supply unit configured to perform the power supply to the electric vehicle via the power transmission coil when the power transmission coil faces the power reception coil, and
a vehicle movement control unit configured to control
making of the electric vehicles park in line one behind another from a power supply space at the head side,
moving of one electric vehicle parked in a leading power supply space of the power supply spaces out of the leading power supply space after stopping the power supply to the one electric vehicle, and
moving of another electric vehicle located behind the one electric vehicle to the power supply space at the head side.

9. A power supply method for wirelessly performing power supply to an electric vehicle having an automatic parking function, the power supply method comprising:
a step of moving the electric vehicle to be supplied with power into power supply spaces in which electric vehicles are to park in line one behind another from a head side to a tail side of the power supply spaces,
a step of performing the power supply to the electric vehicle via a power transmission coil when the power transmission coil faces a power reception coil provided in the electric vehicle, the power transmission coil being provided in each of the power supply spaces,
a step of making the electric vehicles park in line one behind another from a power supply space at the head side,
a step of moving one electric vehicle parked in a leading power supply space of the power supply spaces out of the leading power supply space after stopping the power supply to the one electric vehicle, and
a step of moving another electric vehicle located behind the one electric vehicle to the power supply space at the head side.
